(19) United States
(12) Patent Application Publication
(10) Pub. No.: US 2025/0303661 A1
(43) Pub. Date: Oct. 2, 2025

(54) A DEVICE FOR ADJUSTING AND EQUALIZING THE TENSION IN A WEB-LIKE MATERIAL, AND A SINGLE FACER COMPRISING SAID DEVICE

(71) Applicant: FOSBER S.P.A., Pescaglia (IT)

(72) Inventors: Lorenzo Vannucchi, Pescaglia (IT); Sauro Ruberti, Pescaglia (IT)

(73) Assignee: FOSBER S.P.A., Pescaglia, LU (IT)

(21) Appl. No.: 18/864,120

(22) PCT Filed: May 5, 2023
(86) PCT No.: PCT/EP2023/062040

§ 371 Date: Nov. 8, 2024

(30) Foreign Application Priority Data
May 11, 2022 (IT) 102022000009695

(51) Int. Cl. B31F 1/28; B65H 20/02

(52) U.S. Cl. CPC B31F 1/2836; B31F 1/285; B31F 1/2877; B65H 20/02; B65H 2515/314

(57) ABSTRACT

The device includes a roller for guiding the web-like-material, supported idle about a rotation axis and having a first axial end and a second axial end. Two lateral supports support the guide roller. The guide roller is configured so that the rotation axis thereof may be inclined with respect to a position orthogonal to the advancement direction of the web-like material, to compensate changes in the transversal direction of the tension in the web-like material.

### TECHNICAL FIELD

The present invention relates to machines for processing continuous web-like materials. More particularly, embodiments disclosed herein relate to machines for the production of corrugated board and parts thereof. In this specific case, the invention relates to improvements to the so-called single-facers and parts thereof.

### BACKGROUND ART

Corrugated board is manufactured starting from smooth paper webs, unwound from suitable reels. In the simplest form, the corrugated board consists of a smooth paper web and a corrugated paper web, glued together along the ridges of the flutes of the corrugated paper web. A cardboard web thus formed is referred to in the industry as single face paper board. Usually, to this basic structure there is added a second smooth paper web, glued to the corrugated paper web so that the latter is interposed between the two smooth paper webs, also called liners. In some cases, added to this structure consisting of three paper webs are others with a sequence of corrugated paper webs interposed between smooth paper webs.

The single face paper board is produced by a single facer, comprising a pair of mutually meshing corrugating rollers, between which a first smooth paper web is supplied. The first smooth paper web is hot-deformed into the nip between the two corrugating rollers and it becomes a corrugated paper web. An adhesive is applied on the ridges of the flutes of the corrugated paper web engaged with one of the corrugating rollers and a smooth paper web is pressure-and-heat-applied on the corrugated paper web provided with an adhesive.

A pressing unit comprising at least one pressure member, which is pressed against one of the corrugating rollers, is provided for gluing the corrugated paper web and the smooth paper web to each other. The smooth paper web and the corrugated paper web pass between the corrugating roller and the pressure member.

Examples of single-facers are disclosed in U.S. Pat. Nos. 10,618,242. 8,714,223 and WO2021224142.

The paper webs supplied to the single facer are usually guided about a dancing roller which is used to keep the supply tension constant and absorb speed fluctuations. The dancing roller is usually supported idle by a pair of pivoting arms, stressed by an actuator which keeps the tension of the paper web guided about the dancing roller constant.

Furthermore, equalizer devices are usually provided, having the purpose of keeping the tension of the paper web identical along the transversal direction, that is orthogonally to the direction of advancement of the paper web along the supply path. In other words, means are usually provided, which allow the tension along the right longitudinal edge of the paper web to be substantially identical to the tension along the left longitudinal edge. To this end, equalizer rollers associated with various mechanisms for equalizing the tension on the sides of the paper web are usually used. The evenness of the tension along the width of the paper web is important to keep the paper web correctly guided and with the purpose of obtaining a good-quality product. As a matter of fact, an uneven tension in the transversal direction could cause a change in the pressure with which the paper web is pressed against heating rollers or heating plates. This pressure difference entails a difference in terms of heat transferred to the paper web and therefore an unwanted temperature gradient in the transversal direction, that is in the direction of the width of the paper web. This pressure differential could lead to an uneven gluing in the direction of the width of the corrugated cardboard web obtained at the exit of the single facer, or even to an imperfect planarity of the sheet.

Examples of devices for equalizing the tension of the paper web are disclosed in EP0888993, EP0803458, U.S. Pat. Nos. 5,419,509, 6,206,995, 5,971,313, JP2004-35140, U.S. Pat. No. 5,730,693.

EP1190843 discloses a device for absorbing tension fluctuations in a paper web in a corrugated board production plant. GB2170784 discloses a further system for controlling the tension of a paper web.

In order to obtain a control of the tension and advancement speed, as well as a damping of the tension and speed changes over time, and at the same time equalize the tension along the transversal direction, i.e. the tension in the direction of the width of the paper web, a large number of components and mechanical member along the paper supply path are required.

Therefore, it would be beneficial to provide a system that is simpler and comprising a smaller number of components, to carry out the various functions for controlling the tension of the paper web, in particular in a single facer for the production of corrugated board.

### SUMMARY

In order to overcome or reduce the drawbacks of the prior art, a new device for adjusting and equalizing the tension of a continuous web-like material supplied along a supply path is disclosed herein.

In an embodiment, the device for adjusting and equalizing the tension of a continuous web-like material comprises a roller for guiding the web-like material, supported idle about a rotation axis by a first lateral support and a second lateral support. The first lateral support and the second lateral support are movable along an axis for adjusting the tension of the web-like material. The guide roller, the first lateral support and the second lateral support are configured so that the rotation axis of the guide roller is urged to change the inclination with respect to the tension adjustment axis as a result of a change of the tension of the web-like material along a direction transversal to the advancement direction of the web-like material.

In embodiments described herein, more particularly the device comprises a path for supplying the web-like material and, along such path, a roller for guiding the web-like material. The guide roller is supported idle about a rotation axis. The roller is directly or indirectly constrained to a first lateral support and to a second lateral support. The first lateral support and the second lateral support are provided with a movement for adjusting the tension of the web-like material according to a tension adjustment axis, with respect to a load-bearing structure. In advantageous embodiments, the tension adjustment axis is a pivoting axis orthogonal to the advancement direction of the web-like material and the first support and second support are arms pivoting about the pivoting axis. The possibility of envisaging supports provided with a translation movement, instead of a pivoting movement, along an adjustment axis, which—in this case—is not a pivoting axis, but rather a translation axis lying in a plane orthogonal to the guide roller axis, cannot be ruled out.

The device further comprises at least a first actuator associated with the first lateral support and with the second lateral support, to control the movement for adjusting the tension of the first lateral support and of the second lateral support. In some embodiments, a first actuator associated with the first lateral support and a second actuator associated with the second lateral support are provided. The expression actuator may generally be used to indicate any member suitable to apply an action for controlling or commanding the position of the lateral supports of the guide roller. For example, the actuators may consist of pneumatic cylinder-piston systems acting as a pneumatic spring.

Advantageously, the guide roller is supported so that a tension difference of the web-like material in a direction transversal to the direction for supplying the web-like material, that is in the direction of the width of the web-like material, causes a passive inclination of the rotation axis of the guide roller such to adapt to the tension of the paper and therefore cause a reduction in the tension on the side where it is greater, and an increase in the tension on the side where it is smaller. In other embodiments, the possibility of actively controlling the inclination of the roller so as to compensate changes in the tension in the transversal direction, cannot be ruled out.

With this arrangement, a single guide roller allows to control the tension and/or speed of the web-like material, possibly absorbing tension peaks, and equalizing the tension in the transversal direction, that is in the direction of the width of the web-like material.

Further advantageous embodiments of the device for adjusting and equalizing the tension are described below with reference to attached drawings and defined in the attached claims.

Forming an object of the invention is also a single facer for the production of corrugated board, comprising a first path for supplying a first paper web and a second path for supplying a second paper web. The single facer further comprises a first corrugating roller and a second corrugating roller, mutually defining a corrugating nip for corrugating the first paper web. The first supply path passes through the corrugating nip. A pressure member defines, together with the first corrugating roller, a pressure nip, through which the first supply path and the second supply path extend. The single facer further comprises at least one device for adjusting and equalizing the tension of the web-like material of the type outlined above, in at least one of said first supply path and second supply path.

### BRIEF DESCRIPTION OF THE DRAWINGS

The invention will be clearer from the description and the attached drawings, which illustrate an embodiment provided by way of non-limiting example of the invention. More particularly, in the drawings:

FIG. 1 is a schematic lateral view of a single facer comprising devices for adjusting and equalizing the tension of the paper webs supplied to the corrugating rollers;

FIG. 2 is a cross-section according to a vertical plane parallel to the axes of the corrugating rollers of a device for adjusting and equalizing the tension in an embodiment;

FIG. 3 is a view according to III-III of FIG. 2;

FIG. 4 is a cross-section according to IV-IV of FIG. 2;

FIG. 5 is a cross-section similar to the cross-section of FIG. 2 of a device for adjusting and equalizing the tension in a further embodiment;

FIG. 6 is a view according to VI-VI of FIG. 5;

FIG. 7 is a cross-section similar to the cross-section of FIG. 2 of a device for adjusting and equalizing the tension in a further embodiment;

FIG. 8 is a view according to VIII-VIII of FIG. 7;

FIG. 9 is a cross-section similar to the cross-section of FIG. 2 of a device for adjusting and equalizing the tension in a further embodiment; and

FIG. 10 is a cross-section according to a plane orthogonal to the rotation axis of the guide roller.

### DETAILED DESCRIPTION

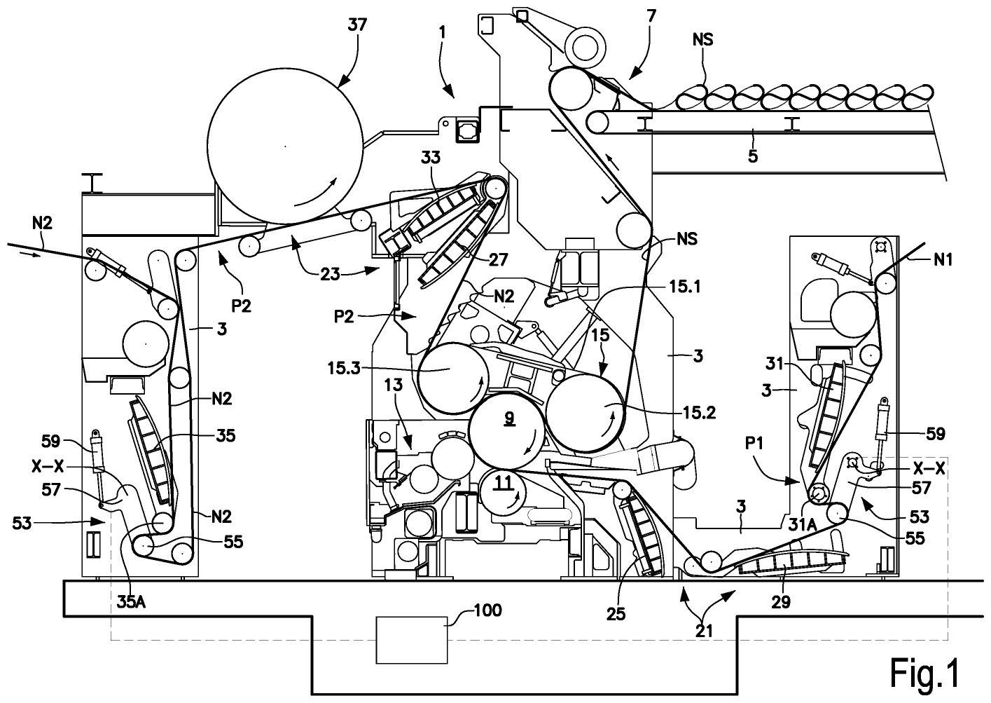

FIG. 1 schematically shows an exemplary embodiment of a single facer 1, in which the invention disclosed herein can be incorporated. It should be noted that the structure of the single facer may also be different from the one shown, for example with regard to the pressure systems for joining the corrugated paper web to the smooth paper web, as regards the pre-heating systems and for any other aspect, consistently with the features of the systems for controlling and equalizing the tension of the paper webs, described below.

In the embodiment of FIG. 1, the single facer 1 comprises a load-bearing structure 3, connected to a bridge 5, along which there is supplied single face paper board NS, formed by the single facer 1 towards further processing stations, not shown, for example a double facer.

The single facer 1 comprises a first supply path P1 for supplying a first paper web N1, coming from a first unwinding device, not shown. The single facer 1 further comprises a second supply path P2 for a second paper web N2 coming from a second unwinding device, not shown. The first paper web N1 forms the corrugated sheet of the single face paper board NS exiting from the single facer 1, while the second paper sheet N2 forms the smooth cover of the single face paper board NS.

Through the lifting device 7, the single face paper board NS produced by the single facer 1 is supplied to the bridge 5, from which the single face paper board NS can be supplied to doble facer so as to be glued to other single face paper board webs coming from other single facers and/or to a second liner to form a corrugated board with one or more waves. In other embodiments, the single face paper board web is directly cut into sheets or rolled into reels, or gathered into flaps.

The single facer 1 comprises a first corrugating roller 9 and a second corrugating roller 11, which cooperate with each other forming a corrugating nip, through which the path for supplying the first paper web N1 extends to be permanently deformed with the formation of flues. The supply path P1 extends through the corrugating nip between the corrugating rollers 9 and 11 and between the corrugating roller 9 and an adhesive dispenser 13, adapted to apply an adhesive on the ridges of the flutes formed on the first paper web N1. The adhesive dispenser 13 is arranged adjacent to the first corrugating roller 9, downstream of the corrugating nip in the direction of advancement of the paper web N1, and cooperates with the first corrugating roller 9. More precisely, the adhesive dispenser 13 is arranged between the corrugating nip, defined by the corrugating rollers 9 and 11, and a pressure member 15, cooperating with the first corrugating roller 9 and defining—with the latter—a pressure nip, for gluing the two paper webs N1, N2 to each other.

In the embodiment of FIG. 1, the pressure member 15 comprises a continuous flexible member 15.1 guided between two guide rollers 15.2 and 15.3. Actuator members (not shown) press the continuous flexible member 15.1 against the cylindrical surface of the first corrugating roller 9. In other embodiments, the pressure member may be configured differently, for example it may comprise a single pressure roller.

The second supply path P2 extends through the pressure nip, between the pressure member 15 and the first corrugating roller 9, so that the first paper web N1 and the second paper web N2 are bonded to each other, through the adhesive applied by the adhesive dispenser 13, passing between the first corrugating roller 9 and the pressure member 15. Gluing occurs due to the pressure and the heat applied to the paper webs N1, N2. To this end, the paper webs N1, N2 are pre-heated before being supplied to the corrugating rollers 9, 11. Furthermore, the corrugating rollers 9 and 11 may be in turn heated to transfer heat to the paper webs N1, N2. Heating may for example be obtained through saturated or overheated steam, which circulates within the corrugating rollers 9, 11, or through any other appropriate source of heat.

In the shown embodiment, along the first supply path P1 there is arranged a first heating system 21 for preheating the first paper web N1, before it comes into contact with the corrugating rollers 9 and 11. Similarly, along the second supply path P2 there is arranged a second heating system 23 for preheating the second paper web N2 before it comes into contact with the first corrugating roller 9 and the pressure member 15.

In some embodiments, the first heating system 21 and the second heating system 23 each comprise at least one stationary heating plate and preferably two stationary heating plates, on which the respective paper web N1 or N2 slides. In other embodiments, preheating rollers may be used instead of stationary heating plates, or in combination therewith.

More particularly, in the embodiment shown in FIG. 1, the first heating system 21 comprises a first heating plate 25 and a second heating plate 29. The second heating system 23 comprises a third heating plate 27 and a fourth heating plate 33.

In the shown embodiment, the first heating system 21 may also comprise a further fifth heating plate 31 and the second heating system 23 may comprise a further sixth heating plate 35.

In the shown embodiment, the second heating system 23 along the second supply path P2 also comprises a heating roller 37.

In advantageous embodiments, each heating element 25, 27, 29, 31, 33, 35, 37 may comprise known adjustment members for adjusting the arc of contact between the respective paper web N1 or N2 and the heating element. For example, such adjustment members may comprise guide rollers which change the arc of contact between the paper web and the heating roller, for example the roller 37, with which there are associated the guide rollers 39A, 39B. When the heating device is a heating plate, it may have an inclination which can be adjusted, to change the arc of contact between the paper web and the active surface of the heating plate.

In advantageous embodiments, in one or in both paths P1, P2, a device for adjusting and equalizing the tension can be provided, which carries out a plurality of functions and in particular: it absorbs, i.e. dampens, tension changes in the paper web; it absorbs, i.e. dampens, changes the paper web supplying speed; and lastly, it equalizes the tension in the paper web in the transversal direction, i.e. it ensures that the tension is approximately constant along the transversal extension of the paper web, so that the tension along the right longitudinal edge is basically approximately identical to the tension along the left edge of the paper web. This contributes to keeping the paper web correctly guided along the path thereof and to obtain an even heating.

As will be clear from the detailed description of various embodiments below, according to the present invention, a system s provided which, for a single paper web, performs all these functions through a single roller for guiding the paper web, suitably supported by lateral supports, for example in form of pivoting arms.

In the embodiment of FIG. 1, in the supply path P1 a first device 53 for adjusting and equalizing the tension for the paper web N1 is inserted. In the shown embodiment, the device 53 for adjusting and equalizing the tension is arranged between the heating plate 31 and the heating plate 29.

In the embodiment of FIG. 1 a device for adjusting and equalizing the tension is provided also along the second supply path P2 of the paper web N2. The device for adjusting and equalizing the tension of the paper web N2 is again indicated with 53, given that the two devices for adjusting and equalizing the tension may be identical or arranged in a mirror-like fashion, or more generally they may carry out the same functions, despite being configured differently, for example according to two different embodiments selected from those described in detail below.

Each device 53 for adjusting and equalizing the tension generally comprises: a guide roller 55; a pair of pivoting arms 57 which support the respective guide roller 55; one or two actuators 59 which act on the pivoting arms 57. An encoder can also be associated with one or both pivoting arms 57, as described in greater detail with reference to the figures below, which show various embodiments of the device 53 for adjusting and equalizing the tension.

Reference number 100 indicates a control unit, which can be functionally connected to the actuators and/or to the encoders or other position sensors associated with the two devices for adjusting and equalizing the tension.

It should be noted that the number of the devices for adjusting and equalizing the tension may be different from the one shown. For example, one of the two paths may be without the device for adjusting and equalizing the tension, more than two devices for adjusting and equalizing the tension can be provided.

Hereinafter, each device 53 for adjusting and equalizing the tension is described with reference to a general web-like material, instead of specifically with reference to the paper web N1 and/or N2, given that the device for adjusting and equalizing the tension may be used in other contexts, where there may arise similar problems and needs for adjusting the tension and equalizing the tension of a continuous web-like material.

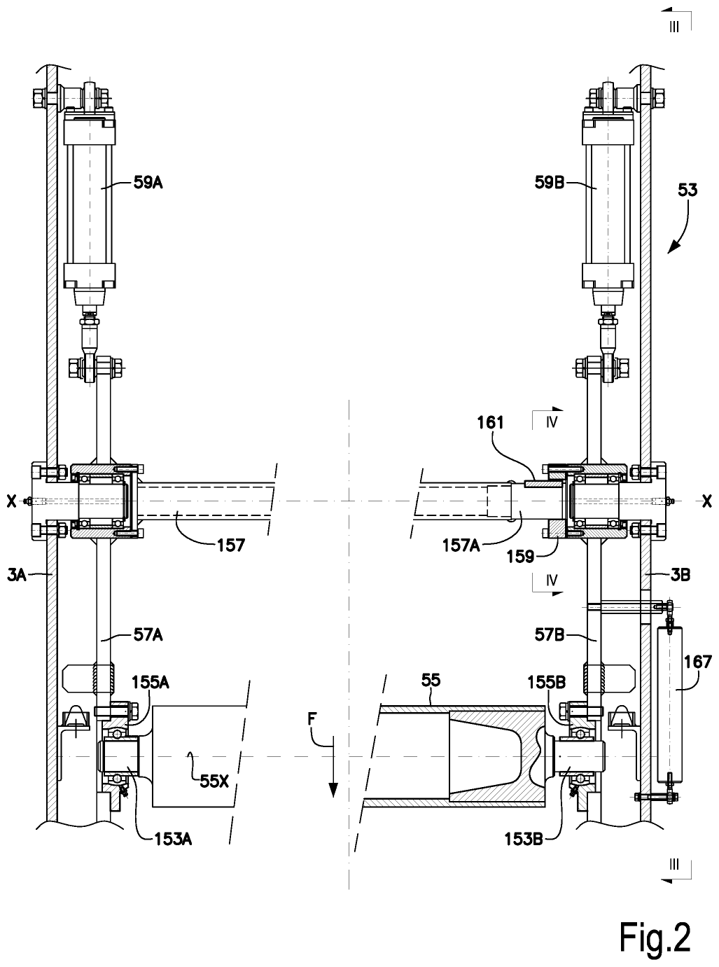

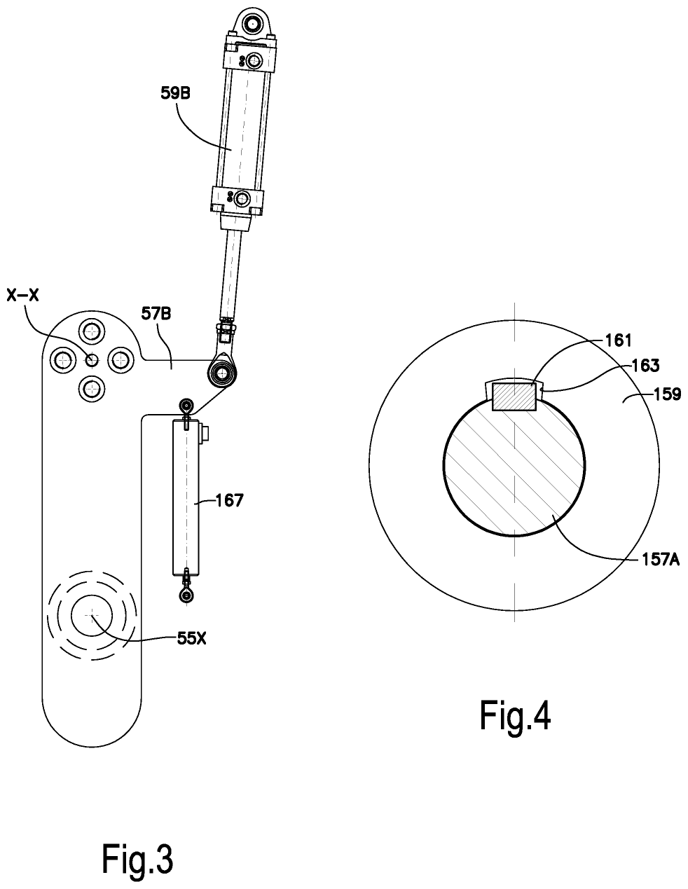

### Embodiment of FIGS. 2 to 4

In general, FIGS. 2 to 4 illustrate a device 53 for adjusting and equalizing the tension comprising a guide roller for guiding the web-like material, supported idle about a rotation axis. The guide roller is supported by two arms pivoting about a common pivoting axis. The pivoting axis forms an axis for adjusting the tension of the web-like material. In other words, the tension of the web-like material, for example the paper web N1 or the paper web N2, is maintained around a constant value by pivoting the pivoting arms and therefore moving the guide roller supported by said pivoting arms. An actuator associated with at least one of the pivoting arms controls the angular position of the pivoting arms, which may be joined to each other by a torsion bar, so that the movement imparted to one of the pivoting arms is transmitted to the other pivoting arm.

In some embodiments, an actuator is provided for each of the two pivoting arms.

In order to ensure that a tension difference of the web-like material in a direction transversal to the supply direction of the web-like material along the supply path causes a pivoting of the rotation axis of the guide roller such to compensate and tend to nullify such tension difference, and therefore to equalize the tension, the guide roller is supported at the first axial end by the first pivoting arm and at the second axial end by the second pivoting arm, for example through spherical bearings or spherical joints, which allow a change in the orientation of the rotation axis of the guide roller with respect to the pivoting arms.

Furthermore, the two pivoting arms are constrained to each other by a torsion bar with a connection which allows a mutual angular displacement, i.e. an angular staggering of the two pivoting arms about the pivoting axis. This angular staggering causes a change in the inclination of the rotation axis of the guide roller with respect to the two pivoting arms.

Basically, the arrangement is such that a tension difference between the two longitudinal edges of the web-like material, that is a tension change in the transversal direction, causes an angular staggering of the two pivoting arms and an ensuing change in the inclination of the rotation axis of the guide roller. The inclination change brings the rotation axis to a position not orthogonal to the advancement direction of the web-like material and an ensuing tension compensation, i.e. to an equalization between the tension on the two longitudinal sides of the web-like material.

Now, referring to the drawings, two sides which are part of the load-bearing structure 3, between which the device for adjusting and equalizing the tension 53 is arranged, are indicated with 3A and 3B in FIG. 2. A first pivoting arm, which is hinged to the side 3A so as to pivot about a pivoting axis X-X which forms the axis for adjusting the tension of the web-like material, is indicated with 57A. A second pivoting arm, hinged to the side 3B so as to pivot about the pivoting axis X-X, is indicated with 57B.

The pivoting arms 57A, 57B support a guide roller, indicated again with 55. The guide roller 55 is supported idle on the pivoting arms 57A and 57B. To this end, the guide roller 55 has two tangs 153A and 153B, respectively at the first axial end and at the second axial end of the guide roller 55. The first tang 151A is supported by a first spherical bearing 155A housed in a seat integrally connected to the first pivoting arm 57A. The second tang 151A is supported by a second spherical bearing 155B housed in a seat integrally connected to the second pivoting arm 57B. The expression spherical bearing is generally used to indicate a bearing which enables the rotation of the guide roller 55 about the rotation axis 55X thereof, and which enables a change in the inclination of the rotation axis 55X.

With this arrangement, the rotation axis 55X of the guide roller 55 may take an angular position which may vary with respect to the pivoting axis X-X of the first pivoting arm 57A and of the second pivoting arm 57B. As clarified below, should the tension of the web-like material, guided about the guide roller 55, be constant along the transversal direction, that is parallel to the axis 55X, the latter shall be parallel to the pivoting axis X-X of the pivoting arms 57A, 57B. On the other hand, should the tension in the web-like material, which advances according to the arrow F, be unbalanced, that is greater on one of the right and left sides of the web-like material and smaller on the other, the inclination of the axis 55X changes so as to equalize the tension, that is it will tend to loosen the side of the web-like material which is more stretched and stretch the side which is less stretched.

The change in the inclination of the axis 55X is a direct result of the tension difference in the transversal direction.

In order to enable the change in inclination of the axis 55X, the two pivoting arms 57A, 57B are connected to each other by a torsion bar 157 coaxial to the pivoting axis X-X, which is connected to the first pivoting arm 57A and to the second pivoting arm 57B so that the two pivoting arms can be angularly staggered one with respect to the other about the axis X-X.

To this end, in the shown embodiment, the torsion bar 157 is rigidly connected to the pivoting arm 57A, so as to rigidly rotate therewith about the axis X-X. On the other hand, the connection between the torsion bar 157 and the pivoting arm 57B is such to leave an angular clearance between the torsion bar 157 and the pivoting arm 57B. The possibility that even the connection between the torsion bar 157 and pivoting arm 57A is performed so as to enable a mutual angular staggering between the torsion bar 157 and the pivoting arm 57A, cannot be ruled out.

In the shown embodiment, as shown in particular in FIG. 4, this ability for angular staggering between the torsion bar 157 and the pivoting arm 57B is obtained as follows. An end 157A of the torsion bar 157 is housed in a ring 159 integrally joined with the pivoting arm 57B. A key 161 is integrally connected at the end 157A of the torsion bar 157, which is housed in a seat 163 formed in the ring 159. The seat 163 has a tangential dimension greater than the width in the tangential direction of the key 161, so that the pivoting arm 57B may rotate about the axis X-X with respect to the torsion bar 157, and therefore with respect to the pivoting arm 57B, by an angle defined by the clearance between the key 161 and the seat 163.

When the tension of the web-like material N1, N2, guided about the guide roller 55, is equal along the axial extension of the guide roller 55, the two pivoting arms 57A, 57B are angularly phased one with respect to the other and the axis 55X of the guide roller 55 is parallel to the pivoting axis X-X. On the other hand, when-for any reason-the tension to which the web-like material N1, N2 is subjected to changes in the transversal direction, the two pivoting arms 57A, 57B are angularly staggered, causing an inclination of the axis 55X with respect to the axis X-X. This inclination tends to rebalance the tension of the web-like material in the transversal direction.

Besides this tension equalizing effect, the device 53 has the function of absorbing fluctuations of the longitudinal tension of the web-like material N1, N2 making the guide roller 55 operate as a dancing roller. In case of fluctuation due to the change in speed or tension, detected by any known system, for example through load cells on the supports of one of the rollers about which the web-like material N1, N2 is guided, the pivoting arms 57A, 57B are pivoted through an actuator or a pair of actuators. In the shown embodiment, an actuator 59A is associated with the pivoting arm 57A and an actuator 59B is associated with the pivoting arm 57B. The movement imparted by the two actuators 59A 59B may be controlled by the central control unit 100.

In other, and currently preferred, embodiments, the actuators 59A, 59B may operate so as to maintain a constant tension in the web-like material N1, N2. In these embodiments, the actuators 59A, 59B are preferably pneumatic actuators, and they may act as simple pneumatic springs or they may be generally configured to maintain a tension of the web-like material N1, N2 substantially constant. In this case, if a tension change in the web-like material guided about the guide roller 55 is generated, the actuator/s 59A, 59B ensure that the position of the guide roller 55 changes in a direction such to tend to nullify the tension change. Typically, should the tension tend to increase, the actuators 59A, 59B (or a single actuator, should only one actuator be provided for) cause the displacement of the roller 55 in a direction such to reduce the path of the web-like material N1, N2. The opposite (increase of the path) occurs in the case of a decrease in tension. Basically, the arms 57A, 57B rotate as a result of the tension change and in the direction which tends to nullify the tension change.

The displacement of the arms may be detected by a position sensor or detector, i.e. an encoder, which—through the central unit 100—causes a change in the operating conditions of the machine, for example an increase or a decrease in the advancement speed of the web-like material N1, N2, which tends to return the guide roller 55 and therefore the arms 57A, 57B to the initial position.

For example, the central control unit 100 may be programmed so as to change the tension or speed for supplying the paper web N1 or N2 as a function of the position of the respective guide roller 55, with a control loop which tends to maintain the position of the guide roller 55, and therefore of the pivoting arms 57A, 57B, around a pre-established position. The position of the arms may be read through an encoder 167 for example associated with the pivoting arm 57B.

In conclusion, with a single guide roller 55, the device for adjusting and equalizing the tension 53 carries out the functions of adjusting the tension and/or the speed for supplying the web-like material (N1, N2), with ensuing damping of the tension peaks for example due to uneven supply, and equalizing the tension in the transversal direction of the web-like material.

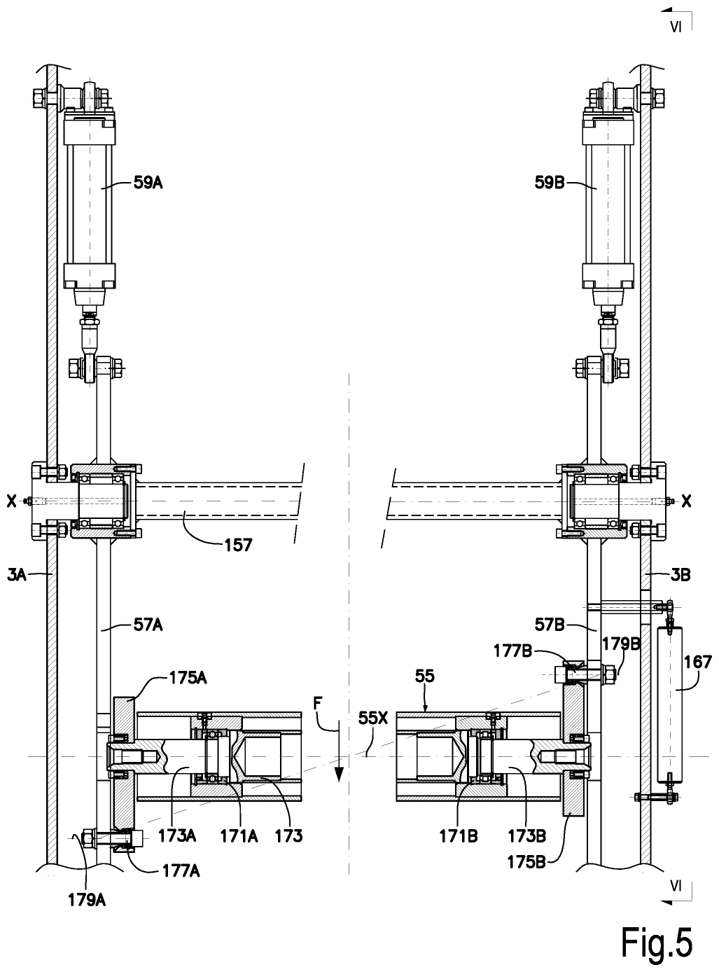

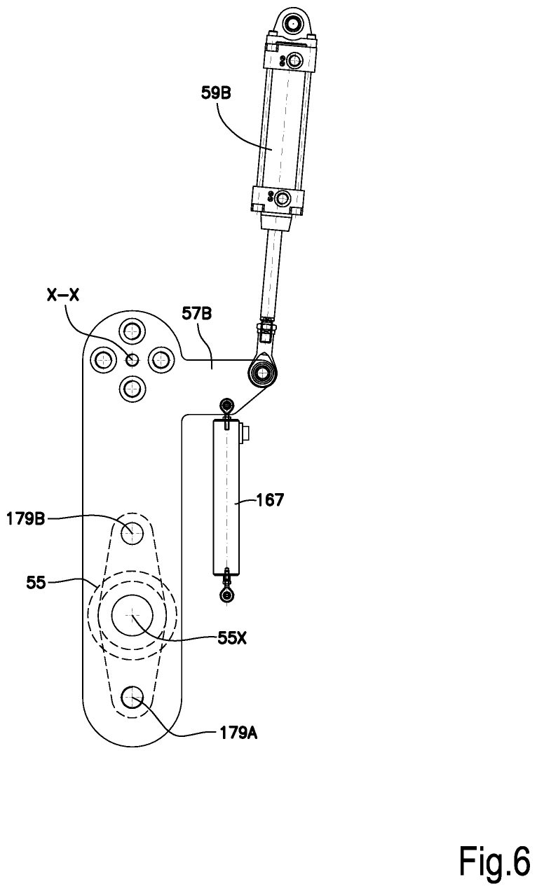

### Embodiment of FIGS. 5 and 6

A second embodiment of a device for adjusting and equalizing the tension 53 is shown in FIGS. 5 and 6. In this embodiment, along the path for supplying the web-like material there is arranged a guide roller for guiding the web-like material, supported idle about a rotation axis. The guide roller is supported by a first pivoting arm and by a second pivoting arm, provided with a pivoting movement about a tension adjustment axis, to which there is associated at least a first actuator for controlling the movement for adjusting the tension of the pivoting arms. The guide roller is supported so that a tension difference of the web-like material in a direction transversal to the direction for supplying the web-like material along the supply path causes pivoting of the rotation axis of the guide roller such to compensate said tension difference.

To this end, the guide roller is supported idle on a support shaft constrained to the first pivoting arm and to the second pivoting arm. Advantageously, a first end of the support shaft is constrained to the first pivoting arm through a first rocker arm hinged to the first arm pivoting about a first hinge axis parallel to the axis for adjusting the tension. A second end of the support shaft is constrained to the second pivoting arm through a second rocker arm hinged to the second arm pivoting about a second hinge axis, parallel to the axis for adjusting the tension. The first hinge axis and the second hinge axis are angularly staggered one with respect to the other about the rotation axis of the guide roller, for example they are arranged at 180° one with respect to the other.

Now, considering the drawings, FIG. 5 shows a section similar to that of FIG. 2 of the device 53 for adjusting and equalizing the tension in this embodiment. Identical numbers indicate parts identical or equivalent to those described above with reference to FIGS. 2 to 4 which will not be described in detail hereinafter.

In the embodiment of FIGS. 5 and 6 the guide roller 55 is supported through bearings 171A, 171B on a shaft 173, provided with a first end 173A and with a second end 173B.

The first end 173A of the shaft 173 is keyed on a first rocker arm 175A, hinged—through a first hinge 177A—to the first pivoting arm 57A. The axis of the hinge 177A is indicated with 179A. The axis 179A is parallel to the axis X-X.

Similarly, the second end 173B of the shaft 173 is keyed on a second rocker arm 175B, hinged—through a second hinge 177B—to the second pivoting arm 57B. The axis of the hinge 177B is indicated with 179B. The axis 179B is parallel to the axis X-X.

The hinges 177A and 177B are obtained with spherical joints, which allow a change in the inclination of the axis of the shaft 173 and of the rocker arms 175A, 175B (which remain orthogonal to each other) with respect to the axes 179A, 179B of the hinges 177A, 177B.

As shown in particular in FIG. 6, the hinge axes 179A, 179B are angularly staggered with respect to the axis 55X. In the shown embodiment, the two axes 179A, 179B are staggered by 180° about the axis 55X.

The two pivoting arms 57A, 57B are constrained to each other by a torsion bar 157 which, for the sake of practicability, is coaxial to the pivoting axis X-X. In the shown embodiment, each pivoting arm 57A, 57B is provided with an actuator 59A, 59B for the purposes described above. The actuators 59A, 59B are functionally connected to the central control unit 100 so as to adjust the speed and/or the tension of the web-like material (paper web N1 or paper web N2), for example with a feedback loop which tends to keep the two pivoting arms 57A, 57B, and therefore the guide roller 55, about a pre-set position.

When the tension in the web-like material is constant, that is uniform, in the transversal direction, the axis 55X of the guide roller 55 is arranged parallel to the adjustment axis X-X. On the other hand, when a tension differential between the right side and the left side of the web-like material is generated, that is when a tension difference in the transversal direction (parallel to the axis X-X) is generated, said tension difference tends to pivot the first rocker arm 175A in a direction around the first hinge axis 177A and pivot the second rocker arm 175B in the opposite direction about the second hinge axis 177B. As a result of this, the axis 55X of the shaft 173 and of the guide roller 55 is inclined with respect to the direction parallel to the axis X-X. This inclination movement tends to equalize the tension in the transversal direction, i.e. it tends to reduce and lastly nullify the tension difference on the two sides of the web-like material N1, N2.

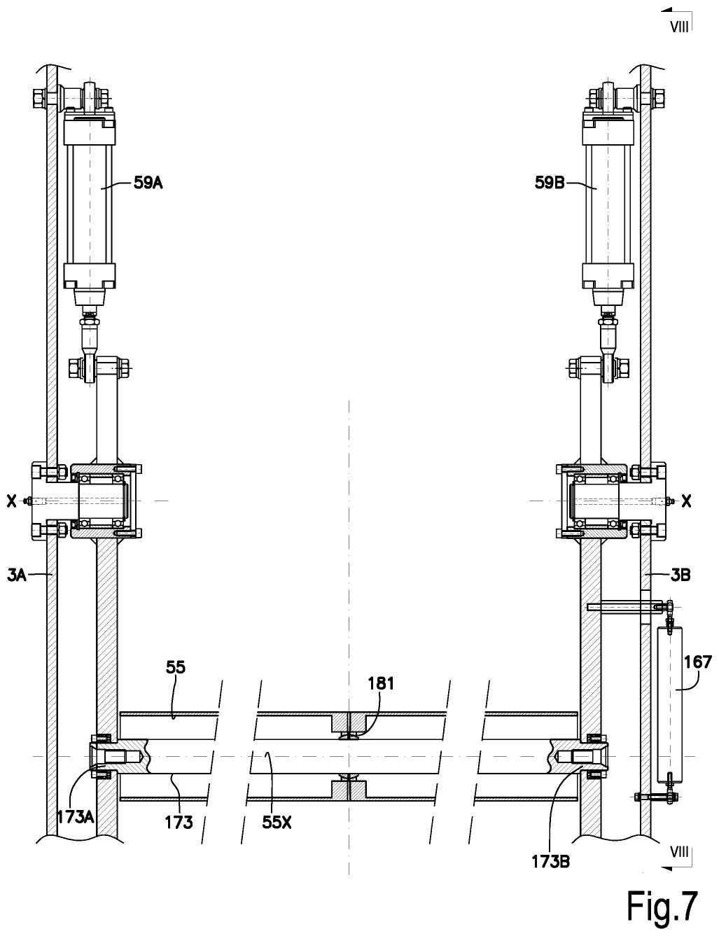

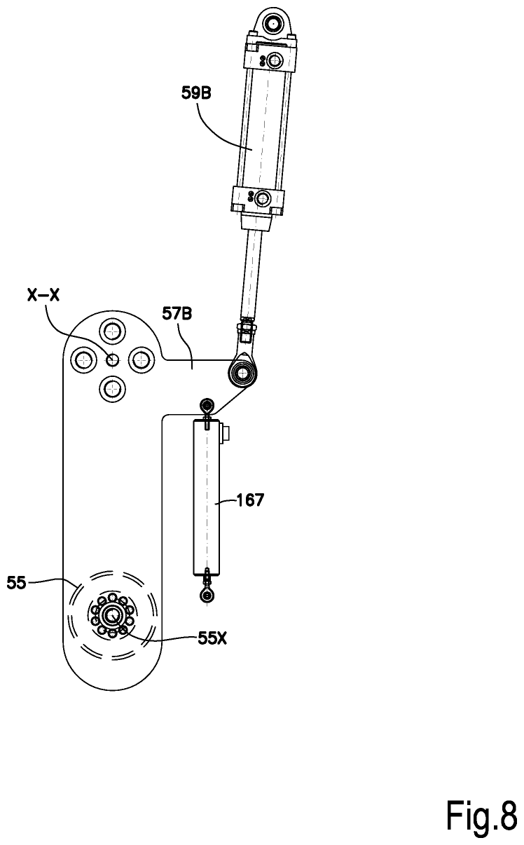

### Embodiment of FIGS. 7 and 8

A further embodiment of a device for adjusting and equalizing the tension 53 of the continuous web-like material is shown in FIGS. 7 and 8.

In this embodiment, along the path for supplying the web-like material there is arranged a roller for guiding the web-like material, supported idle about a rotation axis and constrained to a first pivoting arm and to a second pivoting arm, which are associated with at least one actuator for controlling the movement for adjusting the tension of the first lateral support and of the second lateral support. The guide roller is supported so that a tension difference of the web-like material in a direction transversal to the direction for supplying the web-like material along the supply path causes the rotation axis of the guide roller to pivot such as to compensate said tension difference.

To this end, the guide roller is supported idle on a support shaft constrained to the first pivoting arm and to the second pivoting arm. The support shaft is rigidly connected to the first pivoting arm and to the second pivoting arm and forms a torsion bar which connects the first pivoting arm and the second pivoting arm.

Advantageously, the guide roller is supported idle on the support shaft through an intermediate bearing configured to allow a pivoting of the rotation axis 55X about the center of the support bearing with respect to the support shaft and carry out a tension equalizing function.

Now, considering the drawings, FIG. 7 shows a section similar to that of FIG. 2 of the device 53 for adjusting and equalizing the tension in this embodiment. Identical numbers indicate parts identical or equivalent to those described above with reference to FIGS. 2 to 4, which will not be described hereinafter.

In the embodiment of FIGS. 7 and 8, the guide roller 55 is supported on a shaft 173 coaxial to the guide roller 55. The shaft 173 has a first end 173A rigidly constrained to the first pivoting arm 57A and a second end 173B rigidly constrained to the second pivoting arm 57B. The shaft 173 therefore acts as a torsion bar which connects the two pivoting arms 57A, 57B.

The guide roller 55 is supported in a central position on the shaft 173 through a central bearing 181. The central bearing 181 is a spherical bearing, i.e. a bearing which allows the guide roller 55 to pivot about the center of the bearing 181, so as to change the inclination of the axis 55X of the guide roller 55 with respect to the axis of the shaft 173.

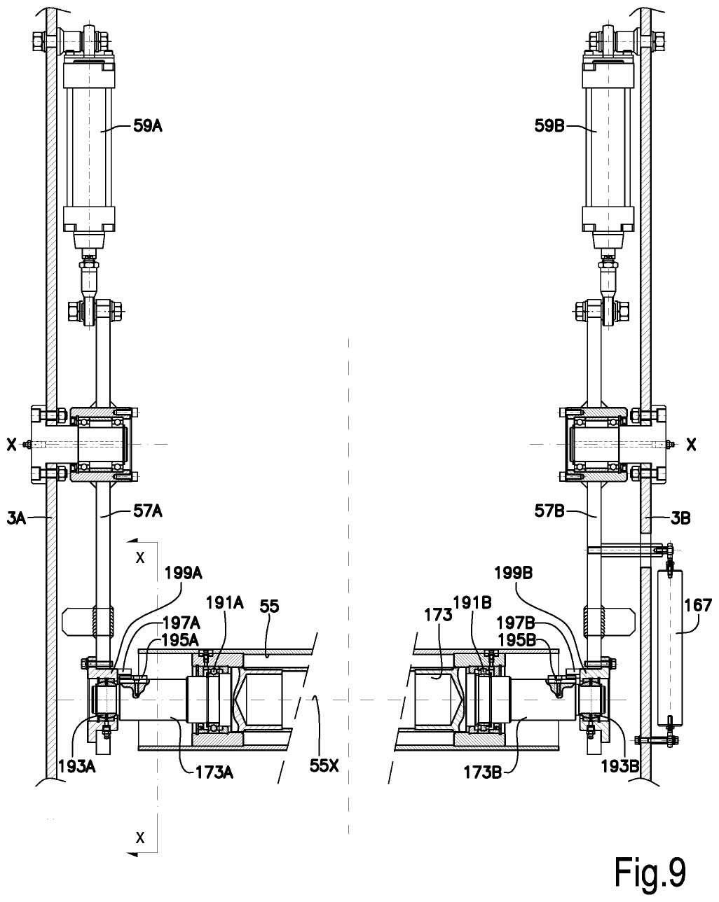

When the tension of the web-like material guided about the guide roller 55 is constant in the transversal direction, the axis 55X of the guide roller 55 coincides with the axis of the shaft 173, as shown in FIGS. 7 and 9. The pivoting arms 57A, 57B can control the tension and/or the speed of the web-like material N1, N2 as described above through the actuators 59A, 59B.

When an unbalanced condition between the tension on the right side and on the left side of the web-like material guided about the guide roller 55 occurs, i.e. when the tension is unbalanced in the transversal direction, the capability of the guide roller 55 to pivot about the center of the bearing 181 enables to equalize the tension. The axis 55X tends to be inclined in the direction which decreases and lastly nullifies the tension difference along the width, i.e. in the transversal direction, of the web-like material.

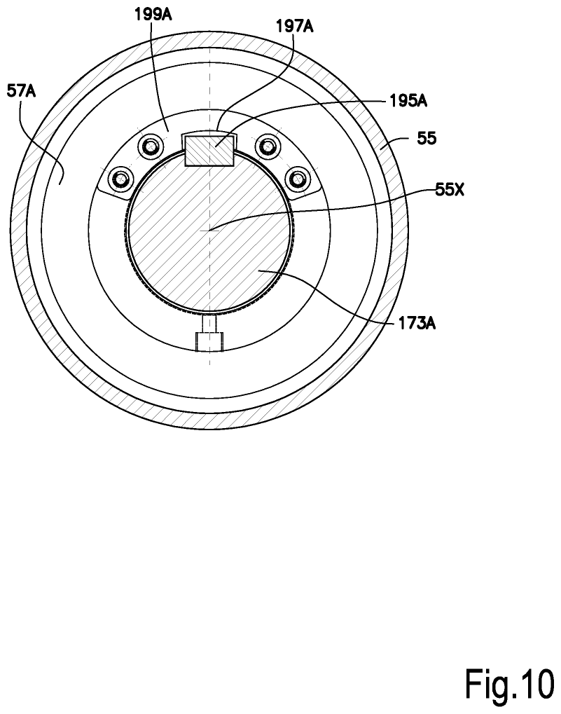

### Embodiment of FIGS. 9 and 10

A further embodiment of the device for adjusting and equalizing the tension 53 is shown in FIGS. 9 and 10.

In this embodiment, along the path for supplying the web-like material a roller for guiding the web-like material is arranged, supported idle about a rotation axis and constrained to a first pivoting arm and to a second pivoting arm, which are associated with at least one actuator for controlling the movement for adjusting the tension of the first lateral support and of the second lateral support.

The guide roller is supported so that a tension difference of the web-like material in a direction transversal to the direction for supplying the web-like material along the supply path causes the rotation axis of the guide roller to pivot such as to compensate said tension difference.

To this end, the guide roller is supported idle on a support shaft constrained to the first pivoting arm and to the second pivoting arm. Furthermore, the support shaft is connected—through spherical joints—to the first pivoting arm and to the second pivoting arm and forms a torsion bar which connects the first pivoting arm and the second pivoting arm. Furthermore, advantageously, the support shaft is constrained—at a first end—to the first pivoting arm and—at a second end—to the second pivoting arm so as to allow a mutual angular movement between the first pivoting arm and the second pivoting arm.

Now, considering the drawings, FIG. 9 shows a section similar to that of FIG. 2 of the device for adjusting and equalizing the tension 53 in this embodiment. Identical numbers indicate parts identical or equivalent to those described above with reference to FIGS. 2 to 4 which will not be described in detail hereinafter.

In this embodiment, the guide roller 55 is supported idle by bearings 191A, 191B on a shaft 173.

The shaft 173 comprises a first end 173A constrained to the first pivoting arm 57A and a second end 173B constrained to the second pivoting arm 57B. The constraint between each end 173A, 173B and the respective pivoting arm 57A, 57B is obtained through a spherical joint 193A and 193B, respectively. The spherical joints allow a change in the inclination of the axis of the shaft 173 with respect to the pivoting arms 57A, 57B.

At least one of the two pivoting arms 57A 57B is constrained to the shaft 173 so as to allow a mutual rotary movement about the axis 55X. In the shown embodiment, both pivoting arms 57A, 57B may rotate with respect to the shaft 173 by a limited angle.

To this end, the end 173A of the shaft 173 is provided with a first key 195A, inserted into a seat 197A (see FIG. 10) formed in a bushing 199A, integrally joined with the pivoting arm 57A. Similarly, the end 173B of the shaft 173 is provided with a second key 195B, inserted into a seat 197B (see FIG. 10) formed in a bushing 199B, integrally joined with the pivoting arm 57B. The dimension in the tangential direction of the two seats 197A, 197B is greater than the tangential dimension of the respective key 195A, 195B. This provides an angular clearance, which allows a relative rotation between the shaft 173 and each of the two pivoting arms 57A, 57B.

In an alternative embodiment, the angular clearance may be provided for only one of the pivoting arms 57A, 57B with respect to the shaft 173.

With this arrangement, a synchronous pivoting of the pivoting arms 57A, 57B under the control of the actuators 59A, 59B controls the tension and/or the speed of the web-like material N1, N2, for example through a control loop which tends to keep the axis of the guide roller 55 around a fixed position, absorbing speed and/or tension changes, like in the embodiments described above.

A tension differential in the transversal direction, i.e. an unbalancing of the tension on the two right and left sides of the web-like material N1, N2, is counter-balanced and therefore equalized due to an ensuing angular pivoting of the shaft 173 with respect to the two pivoting arms 57A, 57B. Basically, the embodiment of FIGS. 9 and 10 is similar to the embodiment of FIGS. 2, 3 and 4, differing in that the torsion bar—with respect to which the two pivoting arms 57A, 57B can limitedly rotate—is arranged coaxially with the guide roller 55, instead of coaxially to the adjustment axis X-X, about which the pivoting arms 57A, 57B pivot.

1-22. (canceled)

23. A device for adjusting and equalizing tension of a continuous web-like material supplied along a supply path; wherein the device comprises:
a path for supplying the web-like material;
a guide roller for guiding the web-like material, supported idle about a rotation axis and having a first axial end and a second axial end;
a first lateral support and a second lateral support for the guide roller, wherein the first lateral support and the second lateral support are provided with a movement for adjusting the tension of the web-like material according to a tension adjustment axis, with respect to a load-bearing structure;
at least a first actuator associated with the first lateral support and the second lateral support for controlling the movement for adjusting the tension of the first lateral support and the second lateral support;
wherein the guide roller is supported so that a tension difference of the web-like material in a direction transversal to a direction for supplying the web-like material along the supply path causes an inclination of the rotation axis of the guide roller such to compensate for said tension difference.

24. The device of claim 23, wherein the tension adjustment axis is a pivoting axis of the first lateral support and of the second lateral support with respect to the load-bearing structure; and wherein the first lateral support comprises a first pivoting arm pivoting about the tension adjustment axis and the second lateral support comprises a second pivoting arm pivoting about the tension adjustment axis.

25. The device of claim 24, wherein the guide roller is supported at the first axial end by the first pivoting arm and at the second axial end by the second pivoting arm.

26. The device of claim 25, wherein the guide roller is supported by the first pivoting arm and the second pivoting arm so that the rotation axis of the guide roller may take variable inclinations with respect to the first pivoting arm and to the second pivoting arm; and wherein the first pivoting arm and the second pivoting arm are constrained to each other by a torsion bar, so as to be able to carry out a mutual angular displacement about the tension adjustment axis, a variation of the inclination of the rotation axis of the guide roller with respect to the first pivoting arm and to the second pivoting arm corresponding to said mutual angular displacement.

27. The device of claim 26, wherein the torsion bar is coaxial to the tension adjustment axis; and wherein at least one of said first pivoting arm and said second pivoting arm is constrained to the torsion bar so as to be able to carry out an angular movement about the tension adjustment axis with respect to the other pivoting arm.

28. The device of claim 27, wherein said at least one pivoting arm is constrained to the torsion bar by a key which allows mutual angular movement between the torsion bar and at least one of said first pivoting arm and said second pivoting arm.

29. The device of claim 26, wherein the guide roller is constrained to the first pivoting arm through a first spherical bearing and to the second pivoting arm through a second spherical bearing.

30. The device of claim 24, wherein the guide roller is supported idle on a support shaft constrained to the first pivoting arm and to the second pivoting arm.

31. The device of claim 30, wherein a first end of the support shaft is constrained to the first pivoting arm through a first rocker arm hinged to the first pivoting arm about a first hinge having an axis parallel to the tension adjustment axis; a second end of the support shaft is constrained to the second pivoting arm through a second rocker arm hinged to the second pivoting arm about a second hinge having an axis parallel to the tension adjustment axis; and wherein the axis of the first hinge and the axis of the second hinge are angularly offset one with respect to another about the rotation of the guide roller,

32. The device of claim 31, wherein the first hinge and the second hinge each comprise a respective spherical joint to allow a respective one of the first rocker arm and the second rocker arm to take a variable inclination with respect to the axis of a respective one of the first hinge and the second hinge.

33. The device of claim 31, wherein the axis of the first hinge and the axis of the second hinge are angularly offset by 180°.

34. The device of claim 31, further comprising a torsion bar which connects the first pivoting arm to the second pivoting arm.

35. The device of claim 30, wherein the support shaft is rigidly connected to the first pivoting arm and the second pivoting arm, the support shaft forming a torsion bar which connects the first pivoting arm to the second pivoting arm.

36. The device of claim 35, wherein the guide roller is supported idle on the support shaft through an intermediate bearing, so as to be able to pivot about a center of the intermediate bearing with respect to the support shaft.

37. The device of claim 30, wherein the support shaft is mounted idle on the first pivoting arm and on the second pivoting arm and forms a torsion bar which connects the first pivoting arm and the second pivoting arm.

38. The device of claim 37, wherein the support shaft is constrained at a first end to the first pivoting arm and at a second end to the second pivoting arm so as to allow mutual angular movement between the first pivoting arm and the second pivoting arm about the tension adjustment axis.

39. The device of claim 38, wherein at least one of said first end and said second end of the support shaft is angularly constrained to a respective one of said first pivoting arm and said second pivoting arm with a key which allows a mutual angular movement between the first pivoting arm and the second pivoting arm about the tension adjustment axis.

40. The device of claim 23, further comprising a first actuator constrained to the first support and a second actuator constrained to the second support.

41. The device of claim 23, further comprising a position detector, for detecting a position of at least one of said first support and said second support.

42. A device for adjusting and equalizing tension of a continuous web-like material supplied along a supply path; wherein the device comprises a roller for guiding the web-like material, supported idle about a rotation axis through a first lateral support and a second lateral support; wherein the first lateral support and the second lateral support are movable along an axis for adjusting the tension of the web-like material; and wherein the guide roller, the first lateral support and the second lateral support are configured so that the rotation axis of the guide roller is stressed to modify inclination with respect to the axis for adjusting the tension as a result of a variation in tension of the web-like material along a direction transversal to an advancement direction of the web-like material.

43. A single facer comprising:
a first supply path for supplying a first paper web;
a second supply path for supplying a second paper web;
a first corrugating roller and a second corrugating roller defining therebetween a corrugating nip of the first paper web, the first supply path passing through the corrugating nip;
a pressure member defining, together with the first corrugating roller, a pressure nip, through which the first supply path and the second supply path pass;
at least one device for adjusting and equalizing the tension of the paper web in at least one of said first supply path and the second supply path;
wherein the device for adjusting and equalizing the tension of the paper web comprises a roller for guiding the web-like material, supported idle about a rotation axis through a first lateral support and a second lateral support; wherein the first lateral support and the second lateral support are movable along an axis for adjusting the tension of the web-like material; and wherein the guide roller, the first lateral support and the second lateral support are configured so that the rotation axis of the guide roller is stressed to modify inclination with respect to the axis for adjusting the tension as a result of a variation in tension of the web-like material along a direction transversal to an advancement direction of the web-like material.
